(19) United States
(12) Patent Application Publication
(10) Pub. No.: US 2019/0057618 A1
(43) Pub. Date: Feb. 21, 2019

(54) Khata (kids have all the answers)

(71) Applicant: Victoria Perry, Moreno Valley, CA (US)

(72) Inventor: Victoria Perry, Moreno Valley, CA (US)

(21) Appl. No.: 15/932,129

(22) Filed: Feb. 8, 2018

Related U.S. Application Data
(60) Provisional application No. 62/605,597, filed on Aug. 21, 2017.

(51) Int. Cl. G09B 19/22; A63F 3/04; A63F 3/00

(52) U.S. Cl. CPC G09B 19/22; A63F 3/0457; A63F 2003/00876; A63F 2003/046; A63F 3/00697

(57) ABSTRACT

KHATA is a multiplication card game like no other. The title KHATA is unique. It is an acronym for ‘Kids Have All The Answers’. The game has a total of 288: 144 fact cards from 1× to 12× and 144 answer cards from 1× to 12×. In the game box there are also two sets of game instructions. One game is for multi-players 3 or more. The second game is to be played with a partner only. In the left corner of the multiplication fact cards, there is a bonus feature that shows the process of addition in relation to multiplication. It is there to demonstrate the short cut multiplication provides when adding the same number multiple times, as well as, the correlation between addition and multiplication. The answer cards are color coded in three different colors. Answer cards for 1× thru 4× are neon blue, answer cards for 5× thru 8× are neon green, and answer cards for 9× thru 12× are neon orange. Bright colors can help with memory skills and player engagement. The games require memory and hand speed. As fact cards are placed down, the player with the corresponding answer card wants to be the first to place it down. Each player wants to be the first to rid their hands of cards. First player out of cards wins. Kids can also feel free to create their own games.

KHATA is a multiplication card game

This game is for kids ages 6 and up
The game has 288 cards and instructions for how to play two games

KHATA is an acronym for ‘Kids Have All The Answers’

144 Multiplication Fact Cards
Each multiplication fact card has a bonus feature in the left corner

144 Answer Cards
The Answer cards are in three different colors: neon blue, neon green, and neon orange.

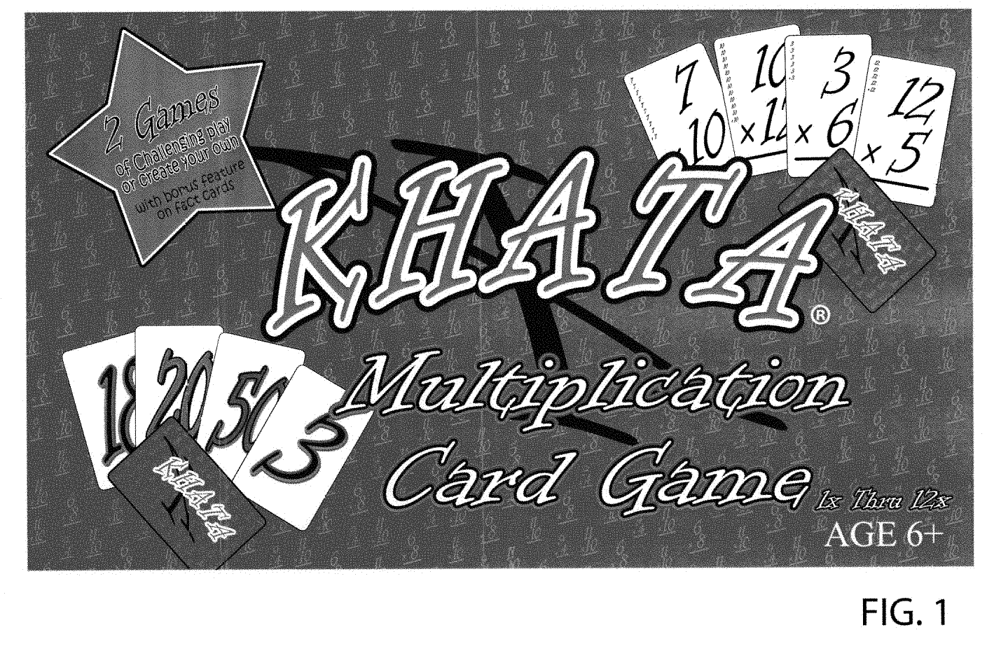

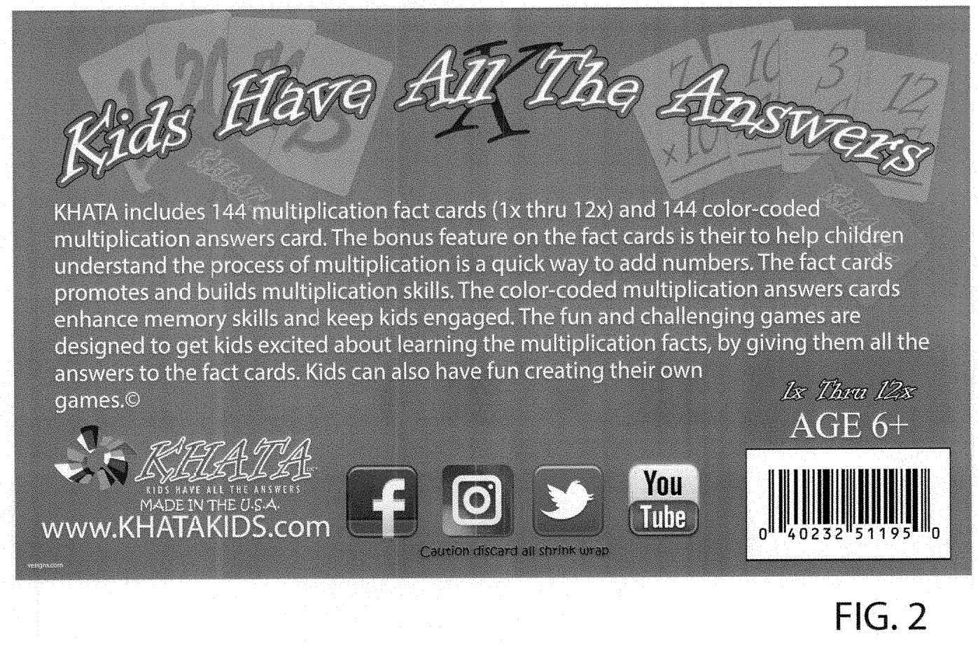

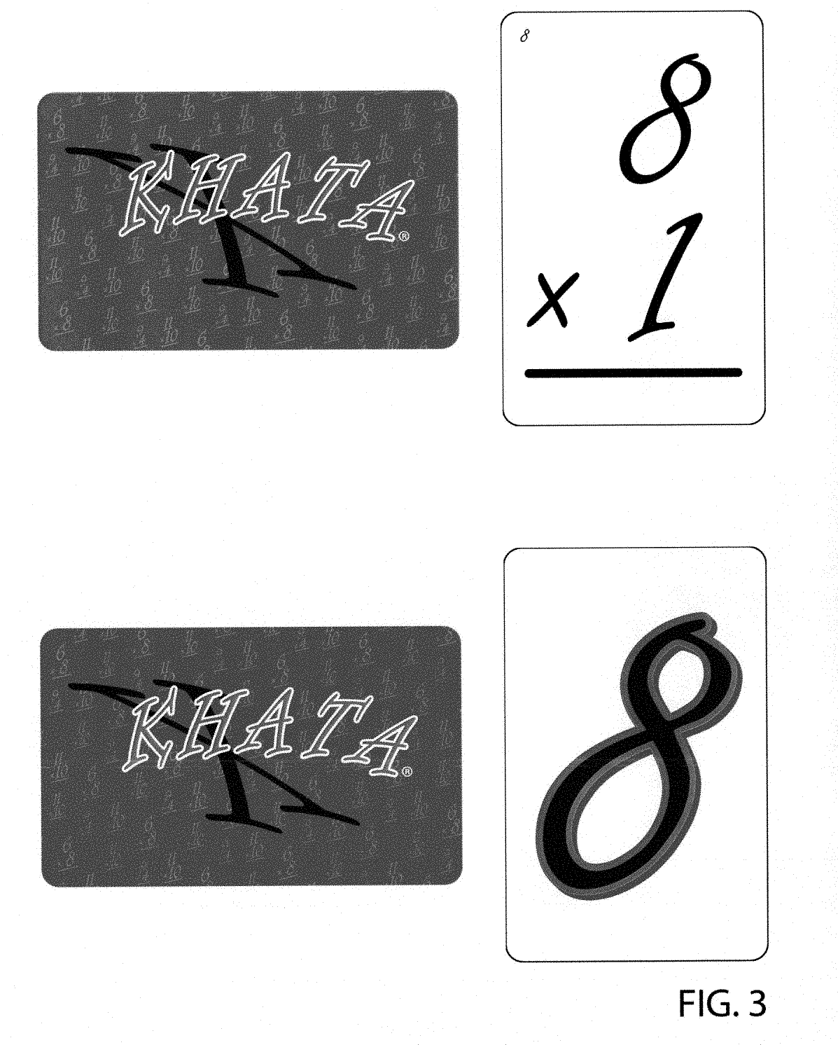

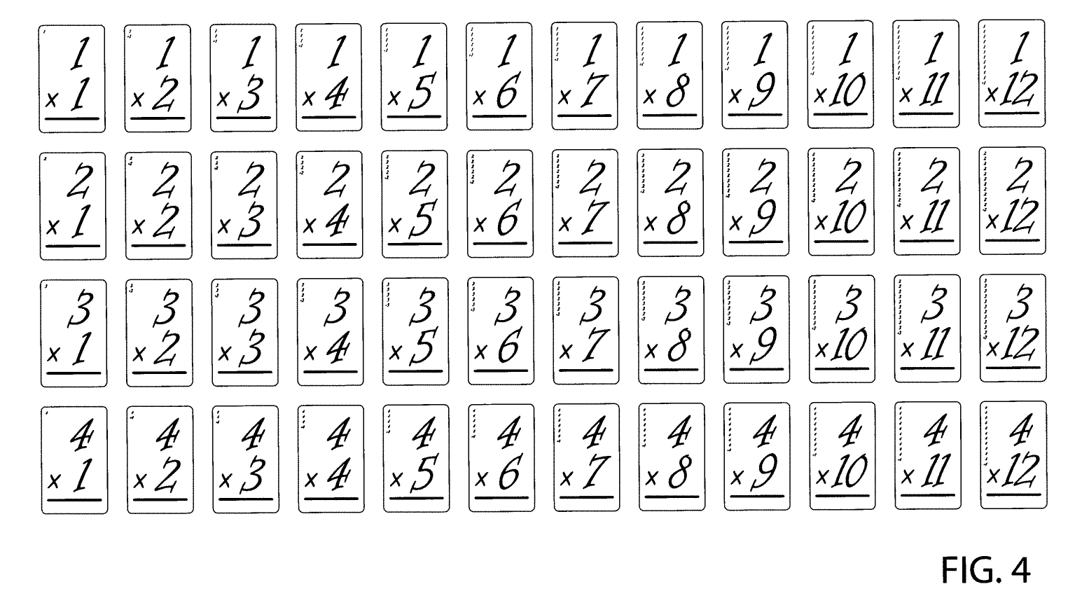

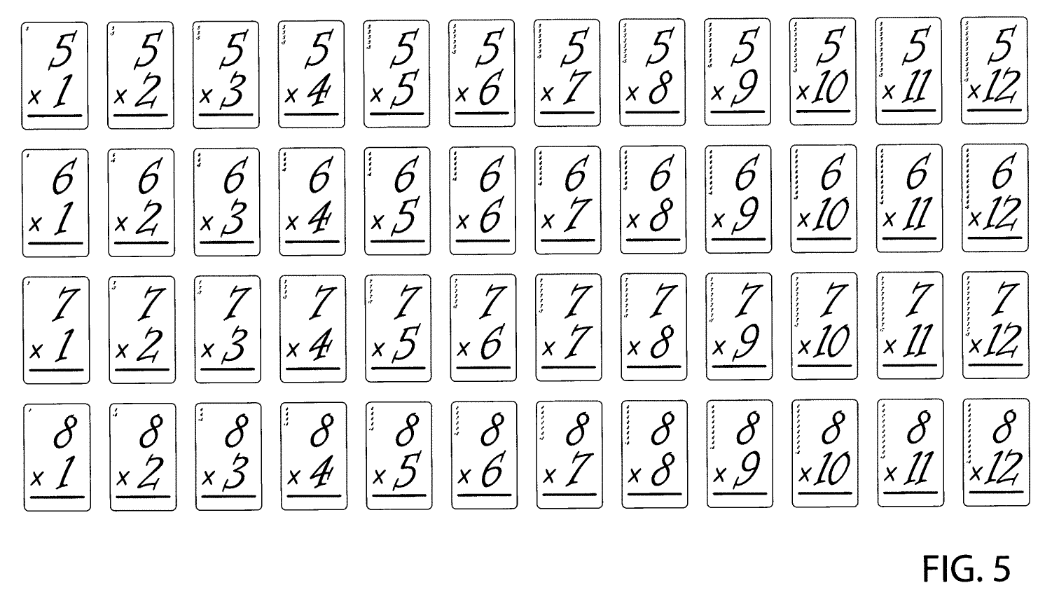

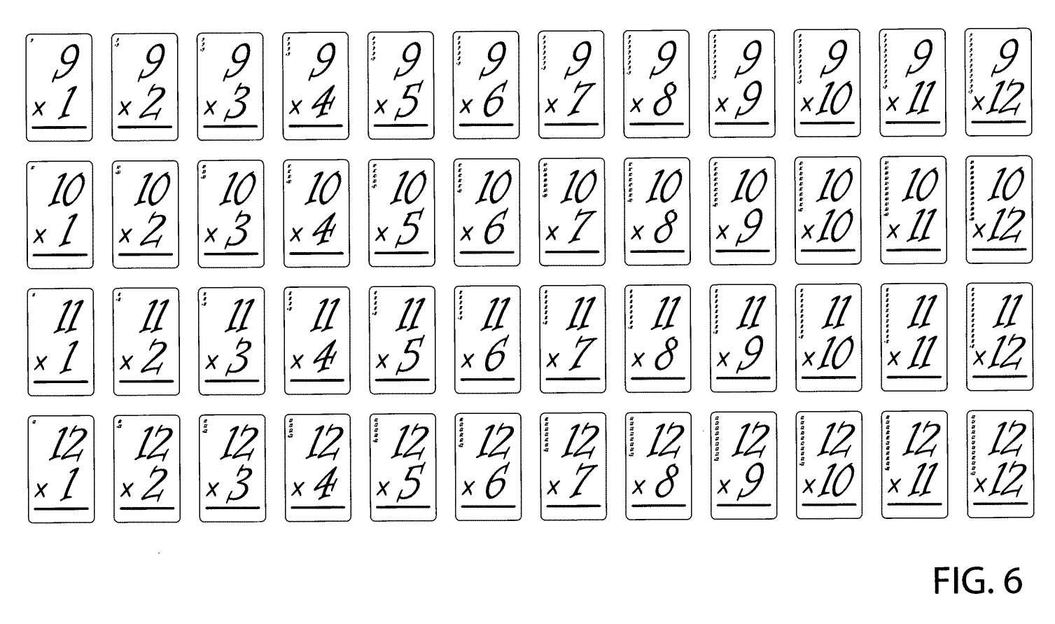

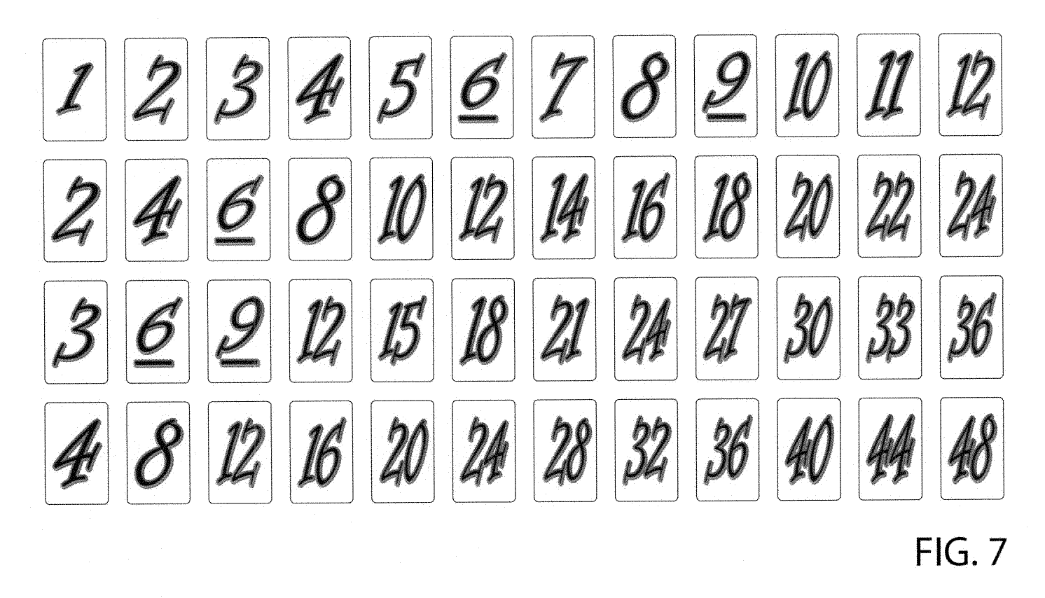

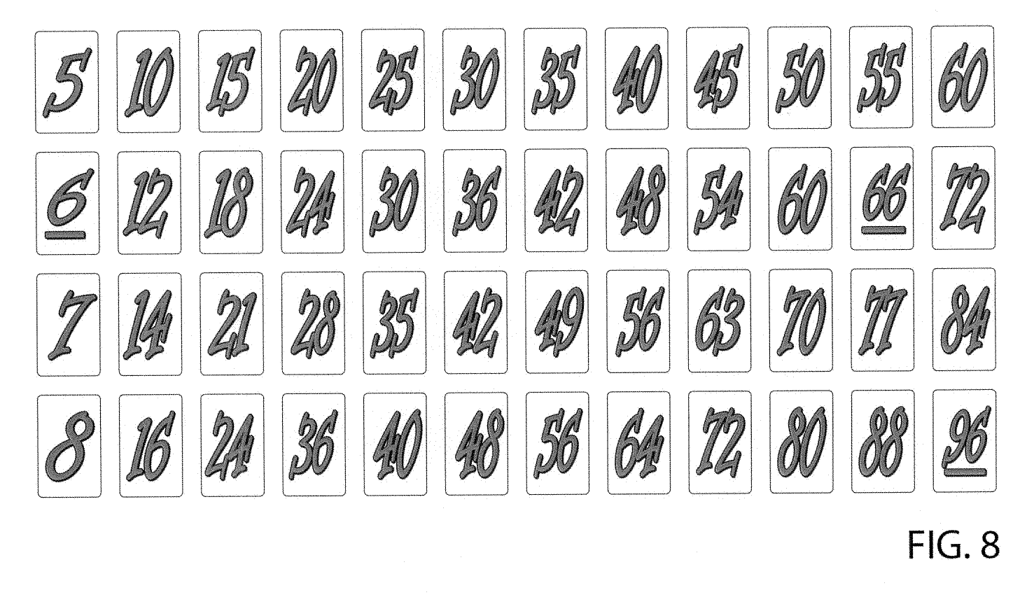

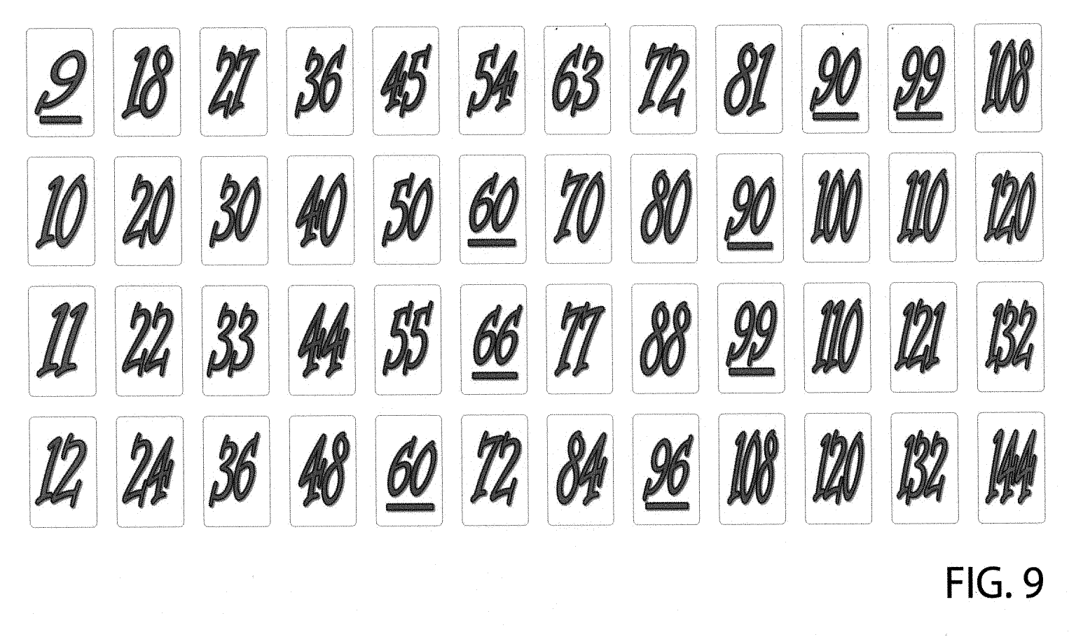

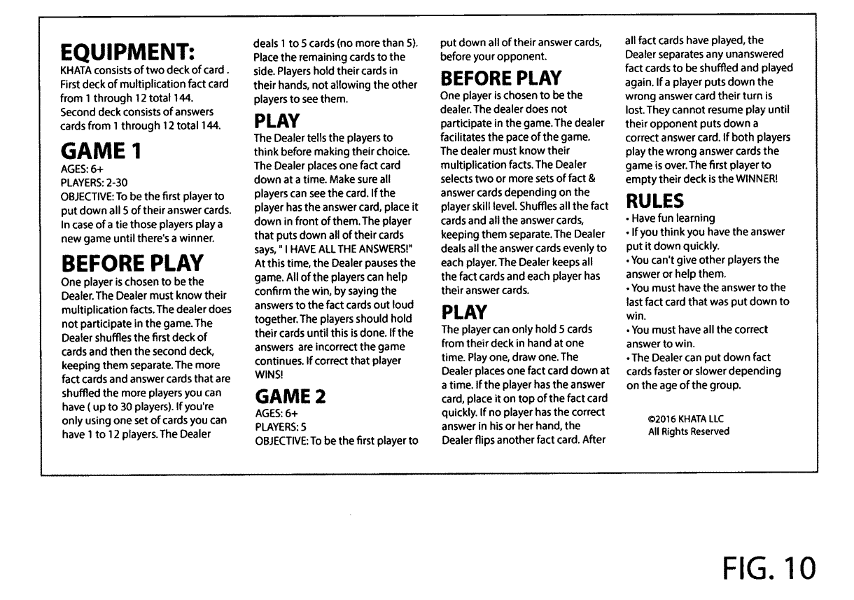

Brief Description of Drawing

| | |
|---|---|
| FIG. 1 | Top of the game box: Name of game, picture of playing |
| | cards, age required to play, number of game instruction |
| | provided, and bonus feature |
| FIG. 2 | Bottom of the game box: KHATA acronym, what is included |
| | in the box, and brief description of game purpose |
| FIG. 3 | Example of front and back of both fact card and answer card |
| FIG. 4 | Multiplication fact cards from l× thru 4× |
| FIG. 5 | Multiplication fact cards from 5× thru 8× |
| FIG. 6 | Multiplication fact cards from 9× thru 12× |
| FIG. 7 | Answer cards in blue from 1-48 correlating to multiplication |
| | facts 1×-4× |
| FIG. 8 | Answer cards in green from 5-96 correlating to multiplication |
| | facts 5×-8× |
| FIG. 9 | Answer cards in orange from 9-144 correlating to |
| | multiplication facts 9×-12× |
| FIG. 10 | Game instructions |

1. KHATA is a multiplication card game. The card game has 288 cards and instructions to play the games multiplication fact cards from 1× to 12× totaling 144 fact and answer cards. The multiplication facts cards have a bonus feature in the left corner of each multiplication card. The bonus feature on the fact card is there to help kids understand the correlation between addition and multiplication. The answer cards are color-coded in three different colors. The bright colors can help with memory skills and keep kids engaged. KHATA also allows for kids to create their own fun games with the cards.
